(19) United States
(12) Patent Application Publication
(10) Pub. No.: US 2012/0174191 A1
(43) Pub. Date: Jul. 5, 2012

(54) METHOD FOR SECURE EXCHANGE OF CONTEXT DATA BETWEEN USERS AND DEVICES

(76) Inventor: Matthew D. Wood, Portland, OR (US)

(21) Appl. No.: 12/982,097

(22) Filed: Dec. 30, 2010

(51) Int. Cl. G06F 21/00

(52) U.S. Cl. 726/4

(57) ABSTRACT

A method for secure exchange of context data between users and devices is generally presented. In this regard, a method is introduced comprising receiving context data over a network link from a first device registered by a user, and selectively forwarding the context data without user input based on permissions previously established by the user. Other embodiments are also disclosed and claimed.

### BACKGROUND

A context aware platform may understand itself, its user, and its surroundings and may adapt to the behavior, make decisions or act on behalf of the user without receiving explicit user inputs. The context aware platform may generate context information and based on the context information, the context aware platform may adapt without receiving explicit user inputs. The context information may be generated using the data provided by the sensors. The sensors may generate the data based on the inputs that the sensors sense. The current context aware platforms, however, lack the ability to securely exchange context information with other devices, users, and web applications.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a block diagram of an example network suitable for implementing a method for secure exchange of context data between users and devices, in accordance with one example embodiment of the invention;

FIG. 2 is a block diagram of an example secure exchange engine, in accordance with one example embodiment of the invention;

FIG. 3 is a flow chart of an example method of establishing context data permissions, in accordance with one example embodiment of the invention;

FIG. 4 is a flow chart of an example method implemented by a secure exchange engine, in accordance with one example embodiment of the invention; and

FIG. 5 is a block diagram of an example storage medium including content which, when accessed by a device, causes the device to implement one or more aspects of one or more embodiments of the invention.

### DETAILED DESCRIPTION

The following description describes embodiments of a technique to handle sensors in a context aware platform. In the following description, numerous specific details such as logic implementations, resource partitioning, or sharing, or duplication implementations, types and interrelationships of system components, and logic partitioning or integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device).

For example, a machine-readable medium may include read only memory (ROM); random access memory (RAM); magnetic disk storage media; optical storage media; flash memory devices; electrical, optical, acoustical or other similar signals. Further, firmware, software, routines, and instructions may be described herein as performing certain actions. However, it should be appreciated that such descriptions are merely for convenience and that such actions in fact result from computing devices, processors, controllers, and other devices executing the firmware, software, routines, and instructions.

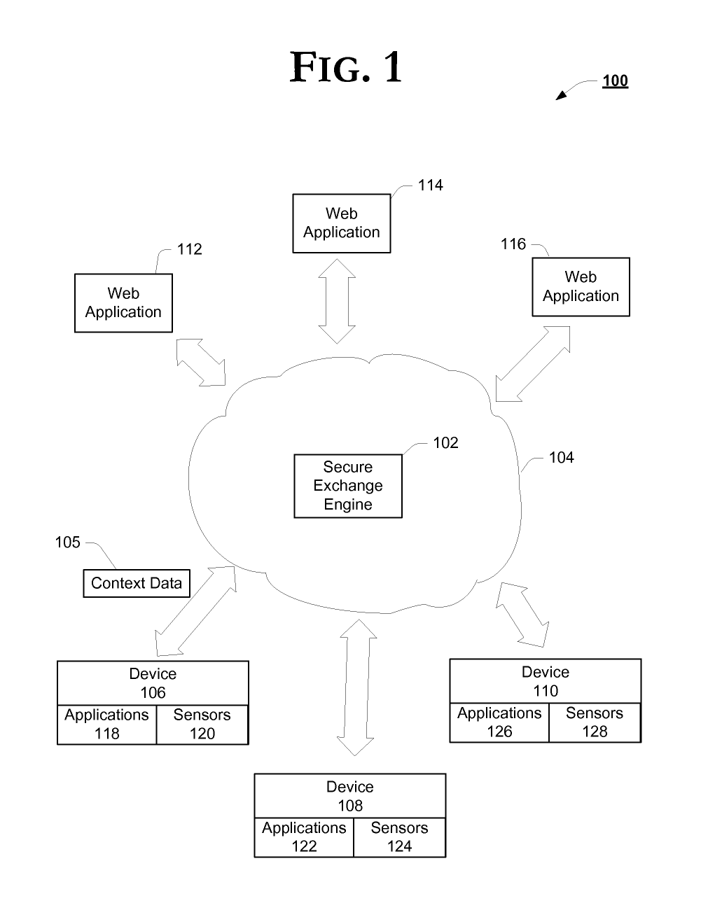

FIG. 1 is a block diagram of an example network suitable for implementing a method for secure exchange of context data between users and devices, in accordance with one example embodiment of the invention. In one embodiment, network 100 may comprise secure exchange engine 102, cloud network 104, context data 105, devices 106, 108 and 110, and web applications 112, 114 and 116. Devices 106, 108 and 110 may include applications 118, 122 and 126 and sensors 120, 124 and 128, respectively.

In one embodiment, a user of device 106 may subscribe to a service for securely exchanging context data between users and devices, which may be implemented by secure exchange engine 102. Secure exchange engine 102 may represent hardware or software or a combination of hardware and software residing anywhere within cloud network 104, which may represent the internet or a local network.

Devices 106, 108 and 110 may represent any type of computing or communication or entertainment device including, but not limited to phones, laptops, desktops, netbooks, tablets, set-top boxes, etc. The user of device 106 may register device 106 along with other devices and/or web applications among which the user authorizes the exchange of context data. In one embodiment, the user may authorize the exchange of context data with web application 112, but not web application 114. In one embodiment, the user may authorize the exchange of context data with web application 116 only when a particular mode is active, for example a shopping or tourist mode, but not when a normal mode is active. The user may also limit the types and amount of access provided to other devices or users. For example, device 108 may also belong to the user of device 106 and may have more permission to context data than device 110, which may belong to a different user.

In one embodiment, context data 105 is generated by sensors 120 and communicated over the internet to secure exchange engine 102. The generation of context data 105 may indicate a location, activity level, mood, schedule, desire or any other context information of device 106 or its user. In one embodiment, sensors 120 are handled according to patent application Ser. No. 12/340,516, entitled, “Handling sensors in a context aware platform,” filed Dec. 19, 2008, which is herein incorporated by reference in its entirety.

After receiving context data 105, secure exchange engine 102 may selectively forward context data 105 without user input based on permissions previously established by the user of device 106. For example, secure exchange engine 102 may forward context data 105 to device 108 and web application 112, based on the nature of context data 105 and the access levels of the various devices and applications.

Applications 118 may affect device 106 in response to actions taken by other devices or web applications in response to context data 105. For example, applications 118 may display on a screen of device 106 information generated by web application 114 in response to context data 105. Applications 118 (and 122 and 126) may include a proxy agent for managing connectivity to secure exchange engine 102 and synchronizing shared context data and access control policies between secure exchange engine 102 and the local device. This proxy agent may have constant network connection with secure exchange engine 102 for real-time synchronization or may only be occasionally connected, depending on the platform.

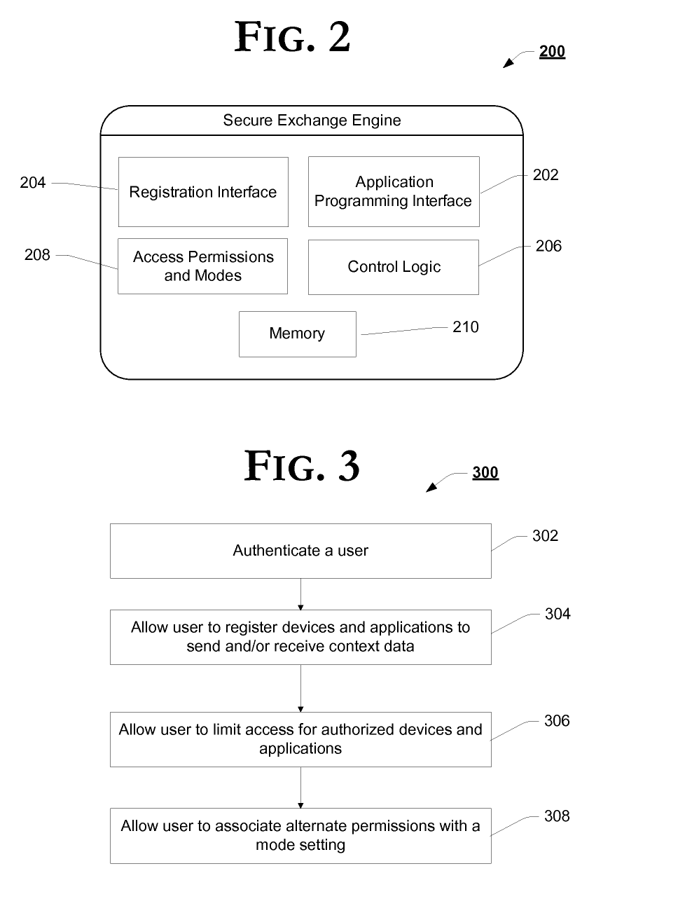

An embodiment of the secure exchange engine 102, which may support secure exchange of context data between users and devices is illustrated in FIG. 2. In one embodiment, the secure exchange engine 200 may comprise application programming interface (API) 202, registration interface 204, control logic 206, access permissions and modes 208, and memory 210.

API 202 allows provisioned devices to discover context data available from peer devices, access and update existing context data, and manage account settings. API 202 may be exposed in both a Representational State Transfer (RESTful) and near-real-time variant. The former may enable simple integration with third party web services and occasionally connected devices, while the latter may enable scenarios where up-to-the-second sharing is necessary. In one embodiment, all communications with secure exchange engine 200 uses mutually authenticated secure connections to protect data in transit and ensure that all access control policies are properly applied. In one embodiment, secure exchange engine 200 is authenticated using Transport Layer Security (TLS) and clients are authenticated using OAuth.

Registration interface 204 allows a user to add and remove devices from their accounts, control data retention policies, and configure access control policies for sharing among their devices and other users. Registration interface 204 may edit and store policies as permissions and modes 208, where permissions represent the limits as to type, duration and other limits of access to context data for a device or application. Modes provide an opportunity for a user to quickly change to an alternate pre-established set of permissions.

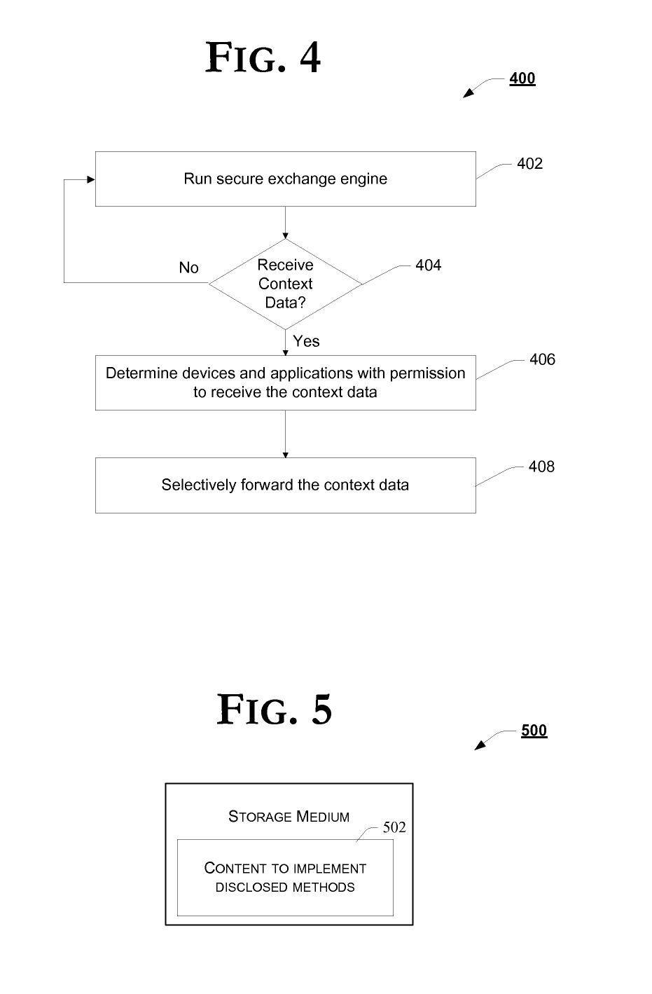

Control logic 206 may allow secure exchange engine 200 to implement a method for secure exchange of context data between users and devices, for example as described in reference to FIG. 4. Control logic 206 may represent any type of microprocessor, controller, ASIC, state machine, etc. Control logic 206 may provide secure exchange engine 200 with the ability to receive context data 105. Control logic 206 may utilize cloud network 104 to broadcast context data to authorized devices and applications. In one embodiment, control logic 206 compares context data 105 with access permissions and modes 208 to develop an authorized broadcast list. In another embodiment, control logic 206 makes context data available for pulling by authorized devices and applications.

In one embodiment, memory 210 is present to store (either for a short-term or a long-term) context data to be pushed to, or pulled by, authorized devices and applications.

FIG. 3 is a flow chart of an example method of establishing context data permissions, in accordance with one example embodiment of the invention.

In block 302, registration interface 204 of secure exchange engine 200 may authenticate a user. In one embodiment, a secure login is provided. In one embodiment, a secure network link with a device associated with the user is established.

In block 304, registration interface 204 of secure exchange engine 200 may allow the user to register devices and applications to send and/or receive context data. In one embodiment, device 108 may be registered to only receive context data from device 106, but not to share any of its own context data.

In block 306, registration interface 204 of secure exchange engine 200 may allow the user to limit access for authorized devices and applications. In one embodiment, a web application may be allowed to receive only certain types context data, for example just location information.

In block 308, registration interface 204 of secure exchange engine 200 may allow the user to associate alternate permissions with a mode setting. In one embodiment, a web application may be allowed to receive context data only when a certain mode, for example a tourist mode, is active.

FIG. 4 is a flow chart of an example method implemented by a secure exchange engine, in accordance with one example embodiment of the invention.

In block 402, control logic 206 of secure exchange engine 200 may implement the policies and procedures of the secure engine.

In block 404, control logic 206 waits for the arrival of context data 105. In one embodiment, context data 105 may come from sensors 120. In one embodiment, context data 105 may come from applications 118.

In block 406, after context data is received, control logic 206 may determine devices and applications with permission to receive the context data. In one embodiment, control logic 206 compares the context data 105 to the current access permissions and modes 208 to determine the authorized web applications and devices.

In block 408, secure exchange engine 200 may selectively forward the context data to authorized web applications and devices. In one embodiment, API 202 is used to broadcast the context data to authorized web applications and device applications. In one embodiment, API 202 makes the context data available for downloading by authorized web applications and device applications.

FIG. 5 is a block diagram of an example storage medium including content which, when accessed by a device, causes the device to implement one or more aspects of one or more embodiments of the invention. In this regard, storage medium 500 includes content 502 (e.g., instructions, data, or any combination thereof) which, when executed, causes the system to implement one or more aspects of methods described above.

The machine-readable (storage) medium 500 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method comprising:
receiving context data over a network link from a first device registered by a user; and
selectively forwarding the context data without user input based on permissions previously established by the user.

2. The method of claim 1, wherein selectively forwarding the context data comprises selectively forwarding the context data to a second device registered by the user.

3. The method of claim 1, wherein selectively forwarding the context data comprises selectively forwarding the context data to a web application registered by the user.

4. The method of claim 1, wherein receiving context data comprises receiving data from a sensor.

5. The method of claim 1, wherein receiving context data comprises receiving data from an application.

6. The method of claim 1, further comprising responding to a change in a mode setting by utilizing an alternate preexisting set of permissions.

7. The method of claim 1, wherein selectively forwarding the context data comprises automatically pushing the context data to authorized devices and web applications.

8. A system comprising:
a registration interface to allow a user to register devices and applications allowed to exchange context data;
an application programming interface to allow applications authorized by the user to access shared context data; and
a secure exchange engine to exchange context data according to permissions set by the user.

9. The system of claim 8, further comprising the registration interface to allow the user to limit the access for each authorized device and application.

10. The system of claim 8, further comprising the registration interface to allow the user to limit the context data that may be shared with authorized devices and applications.

11. The system of claim 8, wherein the secure exchange engine to exchange context data according to permissions set by the user comprises the secure exchange engine to automatically push context data to authorized devices.

12. The system of claim 8, wherein the secure exchange engine to exchange context data according to permissions set by the user comprises the secure exchange engine to allow authorized applications to pull context data.

13. The system of claim 8, further comprising the secure exchange engine to utilize an alternate preexisting set of permissions in response to a change in a mode setting by the user.

14. A machine-readable storage medium comprising content which, when executed by an accessing machine, causes the accessing machine to:
receive context data over an internet connection from a first device registered by a user; and
selectively forward the context data without user input based on permissions previously established by the user.

15. The machine-readable storage medium of claim 14, wherein the content to selectively forward the context data comprises content to selectively forward the context data to a second device registered by the user.

16. The machine-readable storage medium of claim 14, wherein the content to selectively forward the context data comprises content to selectively forward the context data to a web application registered by the user.

17. The machine-readable storage medium of claim 14, wherein the content to receive context data comprises content to receive data from a sensor.

18. The machine-readable storage medium of claim 14, wherein the content to receive context data comprises content to receive data from an application.

19. The machine-readable storage medium of claim 14, wherein the content to selectively forward the context data comprises content to automatically push the context data to authorized devices and web applications.

20. The machine-readable storage medium of claim 14, further comprising content to respond to a change in a mode setting by utilizing an alternate preexisting set of permissions.
